(19) United States
(12) Patent Application Publication
(10) Pub. No.: US 2020/0134676 A1
(43) Pub. Date: Apr. 30, 2020

(54) SYSTEMS AND METHODS TO ADVERTISE

(71) Applicant: Paneau, Inc., San Francisco, CA (US)

(72) Inventors: Nader Khalil, La Jolla, CA (US); Alecsander Fong, Laguna Niguel, CA (US)

(21) Appl. No.: 16/664,376

(22) Filed: Oct. 25, 2019

Related U.S. Application Data
(60) Provisional application No. 62/751,542, filed on Oct. 27, 2018.

(51) Int. Cl. G06Q 30/02; G06F 3/0485

(52) U.S. Cl. CPC G06Q 30/0277; G06F 3/0485; G06Q 30/0269

(57) ABSTRACT

This disclosure presents systems and methods for advertising. Exemplary implementations may: effectuate presentation of an advertiser user interface configured to obtain entry and/or selection of campaign values of campaign attributes of individual advertising campaigns of individual advertiser users; generate individual advertising pages for the individual advertising campaigns based on the campaign values; effectuate presentation of a consumer-facing user interface on consumer-facing computing platforms; direct consumer computing platforms to the individual advertising pages to facilitate presentation of the individual advertising pages; and/or perform other features and/or functionality.

### FIELD

This disclosure relates to systems and methods to advertise.

### BACKGROUND

Small businesses often do not have a venue to advertise on. Billboards, newspapers, etc., are far too expensive to fit in the budget of a small business, and thus they are typically reserved for larger corporations. Small businesses may not have a viable advertisement other than word of mouth.

### SUMMARY

One aspect of the disclosure relates to a system to advertise. One or more implementations of the system may enable small businesses to advertise to users in their neighborhoods and/or add supplemental income to rideshare drivers in a gig economy that are driving near the businesses. One or more components of the system may be implemented by small businesses (“advertiser users”) and/or within vehicle of rideshare drivers and/or autonomous vehicles. A web portal may be accessible to advertiser users to accept new advertising content. A content server may perform content management. A content viewer (“consumer-facing computing platforms”) may be disposed within a vehicle. The consumer-facing computing platforms may show context-sensitive and relevant advertising content for brick-and-mortar stores nearby. The advertising content may be shown in the neighborhoods of the advertiser users that uploaded it. The advertiser users may utilize a configuration page to change a status of the advertising content, to turn it off or on, attach discounts, allow for purchases to be made, and/or integrate other features and/or functionality into their advertising content. Thus, advertiser users may ensure that advertising content may never be old or stale because the content may be dynamically changed. A rider (“consumer”) in the vehicle may consume the advertising content on the consumer-facing computing platform. The rider may utilize a capturing mechanism to send a specially curated campaign advertising page to their personal device (“consumer computing platform”). The campaign advertising page may enable the consumer to perform one or more of reroute the vehicle, place an order or make a reservation, make other relevant purchases (such as tickets or cover charge), and/or perform other features and/or functionality. An interested consumer may be able to save discounts or take action all while they are being rerouted to the business. One or more implementations of the system may encourage interaction, and this interaction may be relayed to businesses in the form of metrics on the web portal.

One or more implementations of a system for advertising may include one or more of one or more servers, one or more advertiser computing platforms, one or more consumer-facing computing platforms, one or more consumer computing platforms, and/or other components.

The one or more servers may include one or more physical processors and/or other components. The one or more servers may communicate with one or more advertiser computing platforms, one or more consumer-facing computing platforms, one or more consumer computing platforms, and/or other components of the system via client/server architecture, and/or other communication schemes. The one or more physical processors may be configured by machine-readable instructions. Executing the machine-readable instructions may cause the one or more physical processor to facilitate advertising. The machine-readable instructions may include one or more computer program components. The computer program components may include one or more of an advertiser component, a campaign component, a presentation component, a consumer component, and/or other components.

The advertiser component may be configured to effectuate presentation of an advertiser user interface on individual advertiser computing platforms associated with advertiser users. An instance of an advertiser user interface may be configured to obtain entry and/or selection of campaign values of campaign attributes of individual advertising campaigns of individual advertiser users and/or other information. The individual campaign values may specify individual characteristics of the individual advertising campaigns. The individual characteristics may include one or more of advertising content, an indication of integration of advertising content into the individual advertising campaigns, and/or other characteristics. The advertising content may include one or more of externally hosted content, one or more campaign-specific ads, and/or other content.

The campaign component may be configured to generate individual advertising pages for the individual advertising campaigns. The individual advertising pages may be generated based on the campaign values and/or other information. The individual advertising pages may facilitate access to, and/or consumption of, the advertising content selected for integration. By way of non-limiting illustration, by virtue of a first advertising campaign of a first advertiser user being specified by one or more of a first campaign value including an integration of first externally hosted content, a second campaign value including an integration of a first campaign-specific ad, and/or other values, a first advertising page may be generated. The first advertising page may include one or more of the first campaign-specific ad, a link to access the first externally hosted content, and/or other content.

The presentation component may be configured to effectuate presentation of a consumer-facing user interface on individual consumer-facing computing platforms. An instance of the consumer-facing user interface may be configured to display one or more of individual campaign-specific ads for the individual advertising campaigns, individual interface elements configured to direct consumer computing platforms of consumers to the individual advertising pages, and/or other content. By way of non-limiting illustration, a consumer-facing user interface presented on one or more consumer-facing computing platforms may display the first campaign-specific ad and a first interface element configured to direct individual consumer computing platforms to the first advertising page.

Individual consumer computing platforms may be configured to detect the individual interface elements. Responsive to the detection of the individual interface elements, the consumer component may be configured to direct the individual consumer computing platforms to the individual advertising pages to facilitate presentation of the individual advertising pages. By way of non-limiting illustration, responsive to a detection of the first interface element by a first consumer computing platform, the first consumer computing platform may be directed to the first advertising page to facilitate presentation of the first advertising page.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system to advertise, in accordance with one or more implementations.

FIG. 2 illustrates a method to advertise, in accordance with one or more implementations.

FIG. 3 illustrates an implementation of a system configured to facilitate advertising.

FIG. 4 illustrates a user interface in accordance with one or more implementations.

FIG. 5 illustrates a user interface in accordance with one or more implementations.

FIG. 6 illustrates a user interface in accordance with one or more implementations.

FIG. 7 illustrates a user interface in accordance with one or more implementations.

FIG. 8 illustrates a user interface in accordance with one or more implementations.

### DETAILED DESCRIPTION

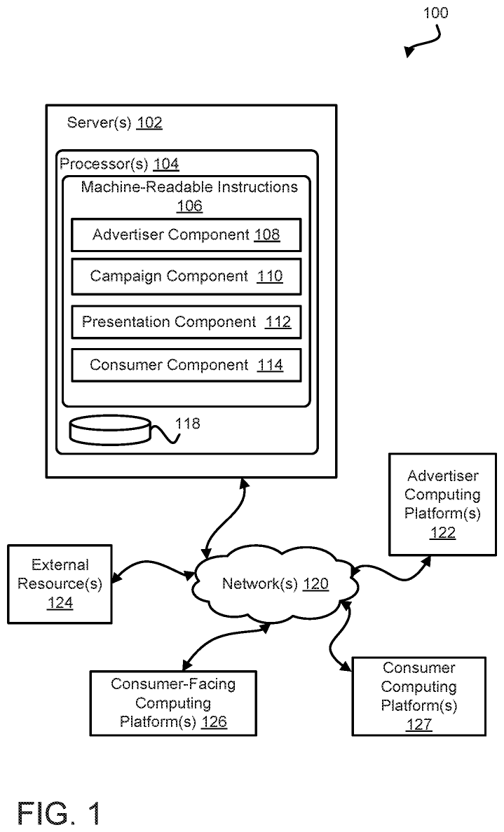

FIG. 1 illustrates a system 100 to advertise, in accordance with one or more implementations. The system 100 may allow for local businesses to advertise dynamically, and provides mechanisms for interaction by consumers with the advertisement. The system 100 may include one or more of one or more servers 102, one or more advertiser computing platforms 122, one or more consumer-facing computing platforms 126, one or more consumer computing platforms 127, and/or other components. A web portal may be accessible to advertiser users to upload advertisements and/or other content for advertising campaigns to a content server (e.g., server(s) 102). The advertiser users may log into an advertiser user interface via the web portal and set and/or modify configuration options of individual advertising campaigns. These settings and/or modifications may be maintained on the content server. One or more content viewers (e.g., one or more consumer-facing computing platforms 126) may share location in real time with the content server, and the content server may respond with a set of ads for the advertising campaigns. A consumer interested in an ad may utilize an interface element displayed alongside the individual ads to pull up individual advertising pages for the individual advertising campaigns on their personal device (e.g., one or more consumer computing platforms 127). On the individual advertising pages, the consumers may perform one or more of viewing additional campaign content, re-routing a current rideshare vehicle to a destination, making reservations or browse a menu if one exists, claiming deals to their mobile wallet, and/or engaging with other features and/or functionality described herein.

The one or more servers 102 may include one or more of one or more physical processors 104, non-transitory electronic storage 118, and/or other components. The non-transitory electronic storage 118 may be configured to store information utilized by one or more servers 102, one or more advertiser computing platforms 122, one or more consumer-facing computing platforms 126, one or more consumer computing platforms 127, and/or other components of system 100.

In some implementations, one or more servers 102 may be configured to provide remote hosting of features and/or functions of machine-readable instructions 106 to one or more of the one or more advertiser computing platforms 122, one or more consumer-facing computing platforms 126, one or more consumer computing platforms 127, and/or other components. One or more of the one or more advertiser computing platforms 122, one or more consumer-facing computing platforms 126, one or more consumer computing platforms 127, and/or other components may be remotely located from one or more servers 102. The one or more servers 102 may communicate with one or more of the one or more advertiser computing platforms 122, one or more consumer-facing computing platforms 126, one or more consumer computing platforms 127, and/or other components via client/server architecture, and/or other communication schemes. By way of non-limiting illustration, individual computing platforms of one or more of the one or more advertiser computing platforms 122, one or more consumer-facing computing platforms 126, and/or one or more consumer computing platforms 127 may download an application (e.g., non-transitory electronically stored information) configured to provide access to features and/or functions of machine-readable instructions 106.

In some implementations, one or more features and/or functions of one or more servers 102 may be attributed as local features and/or functions of individual ones of one or more advertiser computing platforms 122, one or more consumer-facing computing platforms 126, one or more consumer computing platforms 127, and/or other components. For example, individual computing platforms may obtain and/or include machine-readable instructions that may be the same or similar to machine-readable instructions 106 of one or more physical processors 104.

Individual advertiser computing platforms of one or more advertiser computing platforms 122 may include one or more of a mobile computing platform (e.g., one or more of a cellular telephone, a smartphone, a laptop, a tablet computer, and/or other mobile platforms), a stationary computing platform (e.g., a desktop computer), and/or other computing platforms.

Individual consumer-facing computing platforms of one or more consumer-facing computing platforms 126 may include devices configured to present and/or generate content. Content may include visual and/or audio content. An individual consumer-facing computing platform may include one or more of a mobile computing platform (e.g., one or more of a cellular telephone, a smartphone, a laptop, a tablet computer, and/or other mobile platforms), a stationary computing platform (e.g., a desktop computer), and/or other computing platforms. In some implementations, an individual consumer-facing computing platform may include one or more of a display, one or more sensors, one or more transceivers, and/or other components. A display may be configured to present visual content. The visual content may include one or more of individual images, image sequences, video, text, and/or other content. Presentation via a display of a consumer-facing computing platform may be facilitated by one or more processors of the consumer-facing computing platform and/or other components. By way of non-limiting example, presentation may be facilitated by a graphics processing unit (GPU) and/or other components. A display may include one or more of screen, a touchscreen, a monitor, a head-mounted display, a set of screens, and/or other displays.

An individual consumer-facing computing platform of one or more consumer-facing computing platforms 126 may be configured to generate output signals conveying information about a real-world environment surrounding the individual consumer-facing computing platform. A consumer-facing computing platform may include one or more sensors configured to generate output signals. The one or more sensors may in one or more of an image sensor, an audio sensor, a location sensor, and/or other sensors.

An image sensor may be configured to generate output signals conveying image information and/or other information. In some implementations, image information may define one or more of an image, an image sequence, a video, and/or other representations of the real-world space. An image may be defined by a set of pixels and/or other information. Individual pixels in the set of pixels may be defined by one or more of a pixel location, a pixel color, and/or other specifications. A pixel location may include a location on an image plane. Pixel color may be defined by chromaticity of colors specified within a color space, such as an RGB color space. An image sensor may include one or more of a charge-coupled device sensor, an active pixel sensor, a complementary metal-oxide semiconductor sensor, an N-type metal-oxide-semiconductor sensor, and/or other devices.

An audio sensor may generate output signals conveying audio information and/or other information. The audio information may define voice and/or sounds captured by the audio sensor. An audio sensor may include a microphone.

A location sensor may be configured to generate output signals conveying location information and/or other information. Location information derived from output signals of a location sensor may define one or more of a geo-location, an elevation, a planned route, and/or other measurements. A location sensor may include one or more of a GPS, an altimeter, a navigation system, and/or other devices.

The individual consumer-facing computing platform may be disposed in individual vehicles. A vehicle may include one or more of a rideshare vehicle, an autonomous vehicle, and/or other vehicles. A consumer-facing computing platform may be disposed in a vehicle by mounting the consumer-facing computing platform within the vehicle. The mount may be configured to position the consumer-facing computing platform in a manner in which a display may be visually and physically accessible to riders of the vehicle.

Individual consumer computing platforms of one or more consumer computing platforms 127 may include devices configured to present and/or generate content. Content may include visual and/or audio content. An individual consumer computing platform may include one or more of a cellular telephone, a smartphone, a laptop, a tablet computer, a virtual reality platform, a game console, a camera, a desktop computer, a mixed reality headset, augmented reality device, and/or other consumer computing platform. In some implementations, an individual consumer computing platform may include one or more of a display, one or more sensors, one or more audio output devices, and/or other components. A display may be configured to present visual content. The visual content may include one or more of individual images, image sequences, video, text, and/or other content. Presentation via a display of a consumer computing platform may be facilitated by one or more processors of the consumer computing platform and/or other components. By way of non-limiting example, presentation may be facilitated by a graphics processing unit (GPU) and/or other components. A display may include one or more of screen, a touchscreen, a monitor, a head-mounted display, a set of screens, and/or other displays. An audio output device may be configured to present audio content in the form of words, sounds, and/or other audio content. An audio output device may include, for example, a speaker.

An individual consumer computing platform of one or more consumer computing platforms 127 may be configured to generate output signals conveying information about a real-world environment surrounding the individual consumer-facing computing platform. A consumer computing platform may include one or more sensors configured to generate output signals. The one or more sensors may in one or more of an image sensor, an audio sensor, a location sensor, and/or other sensors.

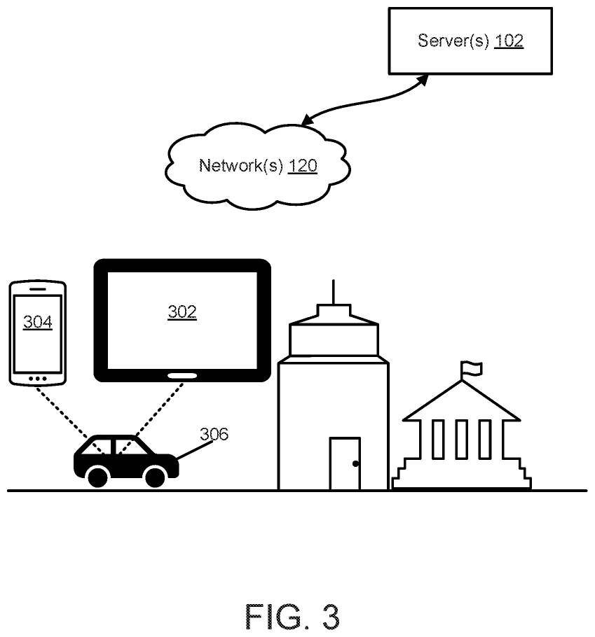

FIG. 3 illustrates an implementation of a system to advertise. The system may include one or more of server(s) 102, consumer-facing computing platform 302, consumer computing platform 304, and/or other components. The server(s) 102, consumer-facing computing platform 302, consumer computing platform 304, and/or other components may communicate via network(s) 120. The consumer-facing computing platform 302 may be associated with a vehicle 306. By way of non-limiting illustration, consumer-facing computing platform 302 may be mounted within vehicle 306 in a manner to provide visual and/or physical access to consumer-facing computing platform 302 by riders in the vehicle 306. Vehicle 306 may include one or more of a rideshare vehicle, an autonomous vehicle, and/or other vehicles. The consumer computing platform 304 may be associated with a consumer of a service being provided by vehicle 306.

Returning to FIG. 1, one or more physical processors 104 of server(s) 102 may be configured by machine-readable instructions 106. Executing machine-readable instructions 106 may cause one or more physical processors 104 to facilitate advertising. The machine-readable instructions 106 may include one or more computer program components. The one or more computer program components may include one or more of an advertiser component 108, a campaign component 110, a presentation component 112, a consumer component 114, and/or other components.

The advertiser component 108 may be configured to effectuate presentation of an advertiser user interface on individual advertiser computing platforms associated with advertiser users. Effectuating presentation may include sending control signals and/or other signals and/or commands to the individual advertiser computing platforms to cause the individual advertiser computing platforms to present an advertiser user interface.

An instance of an advertiser user interface may be configured to obtain entry and/or selection of one or more of profile information, campaign information, and/or other information.

The profile information may include individual advertiser profiles of the individual advertiser users. An individual advertiser profile of an individual advertiser user may include one or more profile values of one or more profile attributes. The individual profile values may specify individual profile characteristics of individual advertiser users and/or other information. In some implementations, the profile attributes may include one or more of a name attribute, a location attribute, a description attribute, and/or other attributes.

A profile value of a name attribute may specify a business name of an advertiser user.

A profile value of a location attribute may specify a business location of an advertiser user. A business location may include one or more of a street address, a city, a neighborhood, and/or other information.

A profile value of a description attribute may specify a business description of an advertiser user. A business description may include one or more of a description of services provided, a description of products sold, a description of a business model, a description of business values/motto, and/or other information.

The campaign information may include campaign values of campaign attributes of individual advertising campaigns of individual advertiser users, and/or other information. The individual campaign values may specify individual characteristics of the individual advertising campaigns. The individual characteristics may include integration of advertising content into the individual advertising campaigns. The advertising content may include one or more of externally hosted content, one or more campaign-specific ads, and/or other content. In some implementations, the campaign attributes may include one or more of a status attribute, an external content attribute, an ad attribute, a routing attribute, a custom content attribute, a scheduling attribute, and/or other attributes.

A campaign value of a status attribute may specify a status of an advertising campaign. A status may include one or more of on (e.g., run the campaign), off (e.g., pause the campaign), and/or other information.

A campaign value of an external content attribute may specify one or more of one or more links to externally hosted content, whether the externally hosted content is integrated, and/or other information. In some implementations, externally hosted content may include one or more of social media content, restaurant-reservation services, on-demand delivery service (e.g., food and/or other goods), digital distribution platform (e.g., App Store), and/or other content.

A campaign value of an ad attribute may specify one or more of content information defining the content of campaign-specific ads (e.g., an image file), whether an individual campaign-specific ad is integrated, and/or other information. A campaign-specific ad may include an image or set of images including an advertisement.

A campaign value of a routing attribute may specify whether there is integration (e.g., via permissions and/or API calls) to reroute a rideshare service application and/or other vehicle transportation application (e.g., as implemented for one or more of an autonomous vehicle, taxi, and/or other vehicle).

A campaign value of a custom content attribute may specify one or more of content information defining custom content, whether custom content is integrated, and/or other information. The custom content may include one or more of propriety content pages (e.g., an Apple® Pass page), content made by the advertiser user, content present on a webpage of the advertiser user, and/or other content.

A campaign value of a scheduling attribute may specify one or more of a time period (or periods) an advertising campaign is being run (e.g., status of “on”). A value may specify one or more of a start date and/or time, an end date and/or time, a span of time, and/or other information.

The campaign component 110 may be configured to generate individual advertising pages for the individual advertising campaigns. The individual advertising pages may be generated based on campaign values, profile values, and/or other information. The individual advertising pages may facilitate access to, and/or consumption of, the advertising content. Access may be provided by links to other content (e.g., embedded URLs), and/or other types of access to online content. Consumption of advertising content may be provided by included instance of the advertising content directly on the individual advertising pages. The individual advertising pages may be stored in electronic storage 118 and/or other storage location. The individual advertising pages may be associated with addresses (e.g., network addresses) where assets defining the individual advertising pages are located within storage 118.

In some implementations, individual advertising pages include scrollable user interfaces. An advertising page may include a vertical arrangement of the advertising content which may be scrolled through to view different portions of the advertising content. Scrolling may be accomplished through user input, for example, finger swiping a touchscreen display of a consumer computing platform.

By way of non-limiting illustration, by virtue of a first advertising campaign of a first advertiser user being specified by one or more of a first campaign value including an integration of first externally hosted content, a second campaign value including an integration of a first campaign-specific ad, and/or other values, a first advertising page may be generated. The first advertising page may include one or more of the first campaign-specific ad, a link to access the first externally hosted content, and/or other content.

The presentation component 112 may be configured to effectuate presentation of a consumer-facing user interface on individual consumer-facing computing platforms. Effectuating presentation may include sending control signals and/or other signals and/or commands to the individual consumer-facing computing platforms to cause the individual consumer-facing computing platforms to present a consumer-facing user interface. An instance of the consumer-facing user interface may be configured to display a limited set of the advertising content of the individual advertising campaigns and/or other content. By way of non-limiting illustration, an instance of the consumer-facing user interface may be configured to display one or more of individual campaign-specific ads for the individual advertising campaigns (e.g., an image including an advertisement), individual interface elements configured to direct consumer computing platforms of consumers to the individual advertising pages, and/or other content. By way of non-limiting illustration, a consumer-facing user interface presented on one or more consumer-facing computing platforms may display the first campaign-specific ad and a first interface element configured to direct individual consumer computing platforms to the first advertising page.

In some implementations, the advertising content presented on a consumer-facing computing platform may be based on location of the consumer-facing computing platform. The presentation component 112 may be configured to obtain location of individual consumer-facing computing platforms. By way of non-limiting illustration, presentation component 112 may send requests for location information to individual consumer-facing computing platforms. Location information may include one or more of a current location (in real time or near real time), one or more past locations, one or more anticipated locations (e.g., via a current route of a vehicle including a consumer-facing computing platform), and/or other information.

In some implementations, presentation component 112 may be configured to select advertising content to present on the consumer-facing user interface of an individual consumer-facing computing platform based on the location of the individual consumer-facing computing platform. Selection may be based on matching the received location information (e.g., one or more of a current location, one or more past locations, and/or one or more anticipated locations) of the individual consumer-facing computing platform with profiles values of the location attribute specifying business locations of the advertiser users. Matching may refer to one or more of an exact match, being within a threshold range, and/or other considerations. By way of non-limiting illustration, an exact match may mean that location of the individual consumer-facing computing platform may pass directly by (or in front of) a business location. By way of non-limiting illustration, being within a threshold range may mean that location of the individual consumer-facing computing platform may come at and/or within a threshold distance of a business location. In some implementations, a threshold range may be specified by an amount of miles, a geofence surrounding the business location, and/or other ranges. In some implementations, a geofence may be defined by boundaries of a local neighborhood in which the business location resides. However, a geofence may be defined in other ways.

In some implementations, the advertising content presented on a consumer-facing computing platform may be based on real-world events. Events may include one or more of sports, concerts, promotions, grand openings, and/or other events. The presentation component 112 may be configured to obtain location of individual consumer-facing computing platforms and/or location of individual real-world events. Presentation component 112 may send requests for location information to individual consumer-facing computing platforms. Location information may include one or more of a current location (in real time or near real time), one or more past locations, one or more anticipated locations (e.g., via a current route of a vehicle including a consumer-facing computing platform), and/or other information. The presentation component 112 may be configured to obtain location of individual consumer-facing computing platforms and/or location of individual real-world events. Presentation component 112 may obtain and/or request location information for individual real-world events from sources of information about the real-world events (e.g., webpages, social media pages, etc.). Location information may include one or more of a current location, one or more past locations, one or more anticipated locations, and/or other information.

The presentation component 112 may be configured to select advertising content to present on the consumer-facing user interface of an individual consumer-facing computing platform based on the location of the individual consumer-facing computing platform and location of one or more real-world events. Selection may be based on matching the received location information of the individual consumer-facing computing platform with location of one or more real-world events. Matching may refer to one or more of an exact match, being within a threshold range, and/or other considerations. By way of non-limiting illustration, an exact match may mean that location of the individual consumer-facing computing platform may pass directly by (or in front of) an event. By way of non-limiting illustration, being within a threshold range may mean that location of the individual consumer-facing computing platform may come at and/or within a threshold distance of an event. In some implementations, a threshold range may be specified by an amount of miles, a geofence surrounding the event, and/or other ranges. In some implementations, a geofence may be defined by boundaries of a local neighborhood in which the real-world event is taking place. A geofence may be defined in other ways. The selected advertising content may include advertising content of business at or near the real-world events, advertising content of the real-world events themselves, and/or other content. By selecting advertising content based on location of one or more real-world events, consumers may garner interest in the real-world events and/or businesses at or near the real-world events.

In some implementations, the advertising content presented on a consumer-facing computing platform may be based on consumer information. Consumer information may include one or more of interests (e.g., in goods, food, brands, companies, etc.), purchase history, wish-lists, and/or other information about consumers. The presentation component 112 may be configured to obtain consumer information from individual consumer computing platforms. By way of non-limiting illustration, users may input consumer information into the consumer computing platforms and provide access to the consumer information to the system 100. In some implementations, consumer information may be obtained from one or more applications (e.g., social media, ride share application, etc.) running on the consumer computing platforms and/or other sources of consumer information. By way of non-limiting illustration, presentation component 112 may be granted one or more permissions to access the consumer information.

The presentation component 112 may be configured to select advertising content to present on the consumer-facing user interface of an individual consumer-facing computing platform based the consumer information. The selected advertising content may include advertising content of business having a business description that may match and/or substantially match the consumer information. By way of non-limiting illustration, advertising content may be selected which may match a consumer's particular interest.

In some implementations, individual consumer-facing computing platforms may be configured to detect presence of one or more consumers viewing a consumer-facing user interface. The individual consumer-facing computing platforms may be configured to obtain image information derived from output signals generated by an individual image sensor included in the one or more consumer-facing computing platforms 126. The detection of presence of one or more consumers based on image information may be accomplished through one or more image-processing techniques. By way of non-limiting illustration, techniques may include facial recognition, and/or other techniques. The presentation component 112 may be configured to obtain, via the consumer-facing computing platforms, counts of consumers viewing individual consumer-facing user interface. In this manner, the system 100 may obtain accurate view counts of the consumer-facing user interface.

Individual consumer computing platforms may be configured to detect the individual interface elements. The individual consumer computing platforms may be configured to obtain image information and/or other information. The image information may be derived from output signals generated by an individual image sensor included in the one or more consumer computing platforms 127. The image information may define images depicting individual interface elements presented on the consumer-facing user interface of the consumer-facing computing platforms. Detection of the individual interface elements may cause the consumer computing platform to present individual advertising pages associated with the campaign-specific ad presented alongside the interface elements.

The individual interface elements may define individual addresses where assets defining the individual advertising pages are located. The interface elements may store information defining the individual addresses. By way of non-limiting illustration, an interface element may include one or more of a barcode, a Quick Response code (QR code), and/or other elements.

The individual consumer computing platforms may be configured to detect, based on the image information and/or other information, presence of individual interface elements. The individual consumer computing platforms may be configured to identify addresses where assets defining the individual advertising pages are located as defined by the individual interface elements. In some implementations, detection of presence and/or identification based on image information may be accomplished through one or more image-processing techniques. By way of non-limiting illustration, techniques may include one or more of computer vision, Speeded Up Robust Features (SURF), Scale-invariant Feature Transform (SIFT), Oriented FAST and rotated BRIEF (ORB), and/or other techniques.

Responsive to the detection of the individual interface elements, the consumer component 114 may be configured to direct the individual consumer computing platforms to the individual advertising pages to facilitate presentation of the individual advertising pages. By way of non-limiting illustration, responsive to a detection of the first interface element by a first consumer computing platform, the first consumer computing platform may be directed to the first advertising page to facilitate presentation of the first advertising page.

In some implementations, directing of the individual consumer computing platforms to the individual advertising pages may be accomplished through one or more of making calls to the addresses defined by the individual interface elements, retrieving the assets at the addresses, rendering views of the individual advertising pages based on the retrieved assets, and/or other processes and/or procedures.

It is noted that while the above description includes a technique of accessing individual advertising pages through image-based detection of individual interface elements, this is for illustrative purposes only and not to be considered limiting. Instead, it is to be understood that individual consumer computing platforms may obtain addresses, obtain assets, and/or render views of the individual advertising pages in other ways. By way of non-limiting illustration, individual consumer computing platforms may be configured to wireless communicate with individual consumer-facing computing platforms. Such wireless communication may include one or more of Bluetooth, Wi-Fi, near-field communication (NFC), and/or other communication techniques. In some implementations, the wireless communication may facilitate the exchange of information between an individual consumer-facing computing platform and consumer computing platform to facilitate the presentation of individual advertising pages on the individual consumer computing platforms. By way of non-limiting illustration, wireless communication of information from a consumer-facing computing platform to a consumer computing platform may cause the consumer computing platform to load a URL on a web browsing application of the consumer computing platform directed to an individual advertising page. Other techniques are contemplated.

In some implementations, an interface element may include an option to send information directly to an individual consumer computing platform. The interface element may comprise a text-input field in which a consumer may provide information identifying a consumer computing platform and/or the consumer. The information identifying the consumer computing platform and/or the consumer may include one or more of a phone number, an email address, and/or other information. The consumer component 114 may be configured to send information to the consumer computing platforms directly which may facilitate the presentation of individual advertising pages on the individual consumer computing platforms. By way of non-limiting illustration, a consumer may input a phone number into a consumer-facing user interface. The consumer component 114 may be configured to send a SMS message to the phone number. The message may include a URL of an individual advertising page and/or other information.

In some implementations, the consumer component 114 may be configured to monitor user engagement with the individual advertising pages. User engagement may include one or more of time-spent viewing an advertising page and/or advertising content of the advertising page, amount and/or direction of scrolling, and/or other information. The consumer component 114 may be configured to effectuate changes to the individual advertising pages in response to the user engagement. Changes may include one or more of adding advertising content to the individual advertising pages that was previously not on the advertising pages, removing advertising content from the individual advertising pages, replacing advertising content of the individual advertising pages with other advertising content that was previously not on the advertising pages, and/or other changes. By way of non-limiting illustration, in response to user engagement conveying a user spent relatively more time viewing a particular campaign-specific ad than an other campaign-specific ad, consumer component 114 may be configured to remove the other campaign-specific ad from the advertising page. By way of non-limiting illustration, in response to user engagement conveying a user spent relatively more time viewing a particular campaign-specific ad than an other campaign-specific ad, consumer component 114 may be configured to add one or more other campaign-specific ads to the advertising page that may be similar to the particular campaign specific ad. Other types and manners of changing individual advertising pages in response to user engagement are contemplated.

The campaign component 110 may be configured to determine business correlation information and/or other information. The business correlation information may include indications of correlations between the individual advertiser users and other ones of the individual advertiser users. The correlations between the individual advertiser users and other ones of the individual advertiser users may be based on one or more of common business location (e.g., within threshold distance, neighborhood, geofence, etc.), common business description (similar and/or complementary goods and/or services), and/or other information.

Consumer component 114 may be configured to generate and/or effectuate presentation of one or more community user interfaces on individual consumer-computing platforms. The community user interface may display user interface elements corresponding to advertising pages of advertiser users having some correlation. Selection of the individual user interface elements may direct the consumer computing platform to the corresponding advertising page. In some implementations, an instance of community user interface may be accessible through user input on an advertising page. The community user interface generated in response to the user input may include user interface elements corresponding to advertising pages of advertiser users having some correlation with the advertising page the user input was initially provided. Accordingly, the individual advertising pages of the individual advertiser users may facilitate access to other ones of the individual advertising pages of the other ones of the individual advertiser users determined to have some correlation.

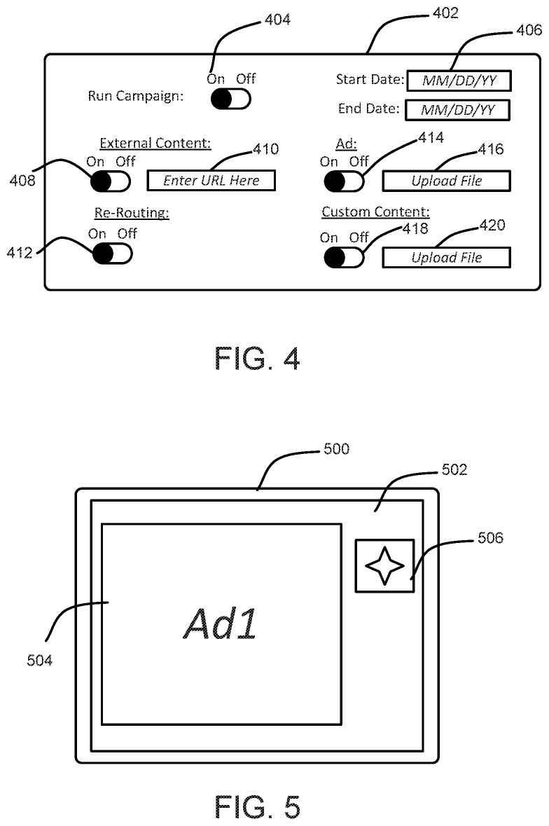

FIG. 4 illustrates an advertiser user interface 402 in accordance with one or more implementations. The advertiser user interface 402 may be configured to obtain entry and/or selection of campaign values of campaign attributes of an advertising campaign. The advertiser user interface 402 may include one or more user interface elements configured to facilitate user interaction for entering and/or selecting campaign values.

A first user interface element 404 may be configured to obtain entry and/or selection of one or more campaign values for a status attribute. By way of non-limiting illustration, the first user interface element 404 may comprise a virtual button configured to obtain entry to change a status of the campaign from “on” to “off” and vice versa.

A second user interface element 406 may be configured to obtain entry and/or selection of one or more campaign values for a scheduling attribute. By way of non-limiting illustration, the second user interface element 406 may comprise one or more text-input fields configured to obtain entry of a time period (or periods) an advertising campaign is “live”.

A third user interface element 408 and/or fourth user interface element 410 may be configured to obtain entry and/or selection of one or more campaign values for an external content attribute. By way of non-limiting illustration, the third user interface element 408 may comprise a virtual button configured to obtain entry to select whether external content is to be integrated into an advertising campaign (e.g., “on” meaning to integrate). The fourth user interface element 410 may comprise one or more text-input fields configured to obtain entry of a URL of the external content.

A fifth user interface element 412 may be configured to obtain entry and/or selection of one or more campaign values for a routing attribute. By way of non-limiting illustration, the fifth user interface element 412 may comprise a virtual button configured to obtain entry to select whether rerouting functionality is to be integrated into an advertising campaign (e.g., “on” meaning to integrate). The external content may comprise a third-party application with which access and one or more permissions may have previously been established. By way of non-limiting illustration, the external content may comprise a ridesharing service application including permissions to reroute rides.

A sixth user interface element 414 and/or seventh user interface element 416 may be configured to obtain entry and/or selection of one or more campaign values for an ad attribute. By way of non-limiting illustration, sixth user interface element 414 may comprise a virtual button configured to obtain entry to select whether ad content is to be integrated into an advertising campaign (e.g., “on” meaning to integrate). The seventh user interface element 416 may comprise a virtual button configured to prompt uploading of a file including information defining the ad content (e.g., an image file).

An eighth user interface element 418 and/or ninth user interface element 420 may be configured to obtain entry and/or selection of one or more campaign values for a custom content attribute. By way of non-limiting illustration, eighth user interface element 418 may comprise a virtual button configured to obtain entry to select whether particular custom content is to be integrated into an advertising campaign (e.g., “on” meaning to integrate). The ninth user interface element 420 may comprise a virtual button configured to prompt uploading of a file including information defining the custom content.

FIG. 5 illustrates a consumer-facing user interface 502 in accordance with one or more implementations. The consumer-facing user interface 502 may be presented on a display of a consumer-facing computing platform 500. The consumer-facing user interface 502 may display one or more of a campaign-specific ad 504, an interface element 506 configured to direct consumer computing platforms of consumers to an individual advertising page, and/or other content.

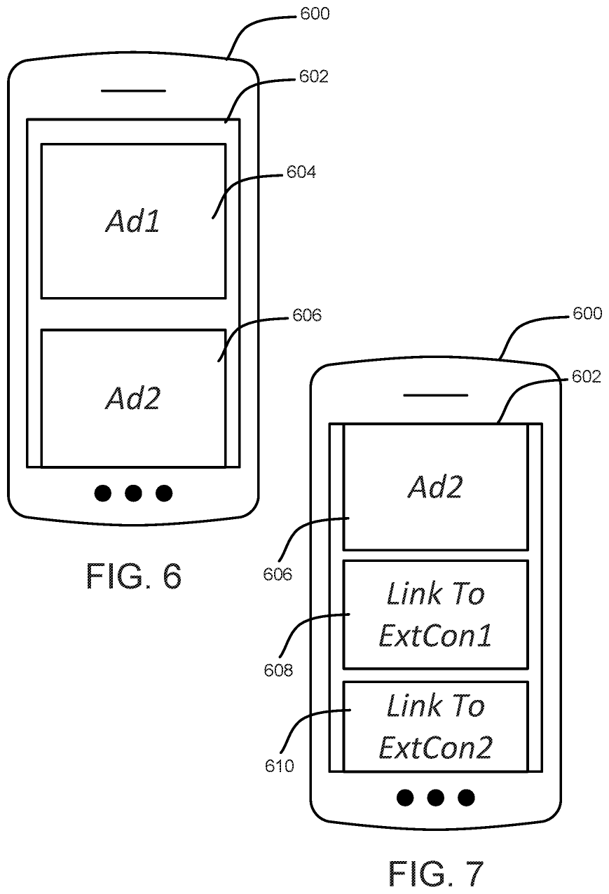

FIG. 6 and FIG. 7 illustrate views of an advertising page 602 in accordance with one or more implementations. The advertising page 602 may be presented on a consumer computing platform 600 in response to detection of an interface element by the consumer computing platform 600. The advertising page 602 may comprise a scrollable user interface. FIG. 6 may represent an initial view of the advertising page 602. FIG. 7 may represent a subsequent view of the advertising page 602 subsequent to a scrolling action by a user of the computing platform 600. The advertising page 602 may facilitate access to and/or consumption of advertising content. By way of non-limiting illustration, the advertising page 602 may include one or more of a first campaign specific ad 604, a second campaign specific ad 606, a first link 608 to first externally hosted content, a second link 610 to second externally hosted content, and/or other content.

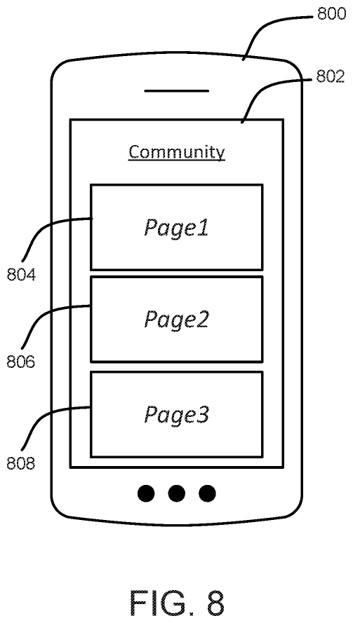

FIG. 8 illustrates a community user interface 802 in accordance with one or more implementations. The community user interface 802 may be presented on a consumer computing platform 800. The community user interface 802 may display user interface elements (e.g., virtual buttons, links, and/or other elements) corresponding to advertising pages of related advertiser users. Selection of the individual user interface elements may direct the consumer computing platform 800 to the corresponding advertising page. By way of non-limiting illustration, the user interface elements may include one or more of a first user interface element 804 corresponding to a first advertising page, second user interface element 806 corresponding to a second advertising page, a third user interface element 808 corresponding to a third advertising page, and/or other user interface elements.

Returning to FIG. 1, server(s) 102, one or more advertiser computing platforms 122, one or more consumer-facing computing platforms 126, one or more consumer computing platforms 127, external resource(s) 124, and/or other components may be operatively linked via one or more electronic communication links. For example, such electronic communication links may be established, at least in part, via one or more networks 120. One or more networks 120 may include the Internet, Bluetooth, and/or other networks. It will be appreciated that this is not intended to be limiting and that the scope of this disclosure includes implementations in which components of system 100 may be operatively linked via some other communication media.

External resource(s) 124 may include sources of information, hosts, and/or providers of information outside of system 100, external entities participating with system 100, and/or other resources. In some implementations, some or all of the functionality attributed herein to external resource(s) 124 may be provided by resources included in system 100.

Server(s) 102 may include communication lines or ports to enable the exchange of information with one or more of a network, advertiser computing platform(s) 122, consumer-facing computing platform(s) 126, consumer computing platform(s) 127, and/or other components. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may include electronic storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port or a drive. A port may include a USB port, a firewire port, and/or other port. A drive may include a disk drive and/or other drive. Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 118 may include one or more virtual storage resources (e.g., cloud storage, a virtual private network, and/or other virtual storage resources). Electronic storage 118 may store software algorithms, information determined by processor(s) 104, information received from computing platform(s) 122, and/or other information that enables system 100 to function as described herein.

Processor(s) 104 may be configured to provide information-processing capabilities in server(s) 102. As such, processor(s) 104 may include one or more of a digital processor, an analog processor, a digital circuit designed to process information, an analog circuit designed to process information, a state machine, and/or other mechanisms for electronically processing information. Although processor(s) 104 is shown in FIG. 1 as a single entity, this is for illustrative purposes only. In some implementations, processor(s) 104 may include one or more processing units. These processing units may be physically located within the same device, or processor(s) 104 may represent processing functionality of a plurality of devices operating in coordination. The processor(s) 104 may be configured to execute components 108, 110, 112, and/or 114. Processor(s) 104 may be configured to execute components 108, 110, 112, and/or 114 by software; hardware; firmware; some combination of software, hardware, and/or firmware; and/or other mechanisms for configuring processing capabilities on processor(s) 104.

It should be appreciated that although components 108, 110, 112, and/or 114 are illustrated in FIG. 1 as being co-located within a single processing unit, in implementations in which processor(s) 104 includes multiple processing units, one or more of components 108, 110, 112, and/or 114 may be located remotely from the other components. While computer program components are described herein as being implemented via processor(s) 104 through machine readable instructions 106, this is merely for ease of reference and is not meant to be limiting. In some implementations, one or more functions of computer program components described herein may be implemented via hardware (e.g., dedicated chip, field-programmable gate array). One or more functions of computer program components described herein may be one or more of software-implemented, hardware-implemented, and/or software and hardware-implemented. The description of the functionality provided by the different components 108, 110, 112, and/or 114 described above is for illustrative purposes and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, 114, and/or other components. As another example, processor(s) 104 may be configured to execute one or more additional components that may perform some or all of the functionality attributed to one of components 108, 110, 112, and/or 114.

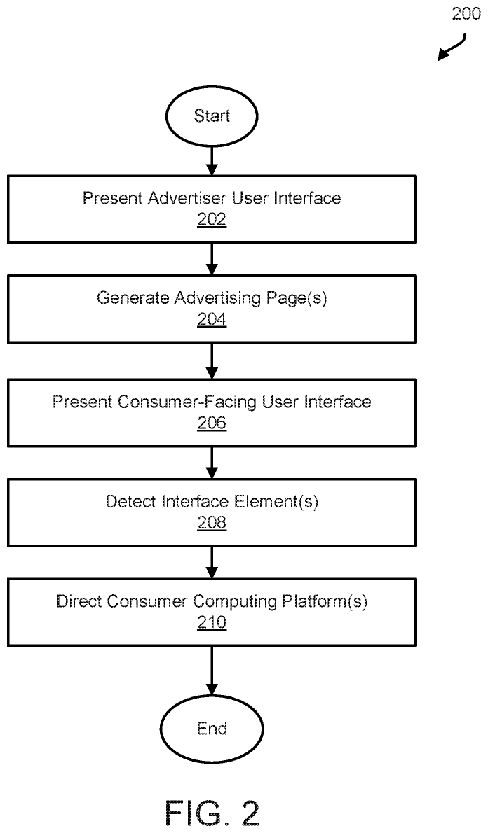

FIG. 2 illustrates a method 200 to advertise. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in a system comprising one or more processing devices (e.g., a digital processor, an analog processor, a digital circuit designed to process information, an analog circuit designed to process information, a state machine, and/or other mechanisms for electronically processing information), storage media storing machine-readable instructions, one or more consumer-facing computing platforms, one or more consumer computing platforms, and/or other components. The one or more processing devices may include one or more devices executing some or all of the operations of method 200 in response to instructions stored electronically on electronic storage media. The one or more processing devices may include one or more devices configured through hardware, firmware, and/or software to be specifically designed for execution of one or more of the operations of method 200.

At an operation 202, presentation may be effectuated of an advertiser user interface on individual advertiser computing platforms associated with advertiser users. An instance of an advertiser user interface may be configured to obtain entry and/or selection of campaign values of campaign attributes of individual advertising campaigns of individual advertiser users and/or other information. The individual campaign values may specify individual characteristics of the individual advertising campaigns. The individual characteristics may include integration of advertising content into the individual advertising campaigns. The advertising content may include one or more of externally hosted content, one or more campaign-specific ads, and/or other content. In some implementations, operation 202 may be performed by one or more physical processors executing an advertiser component the same as or similar to advertiser component 108 (shown in FIG. 1 and described herein).

At an operation 204, individual advertising pages may be generated for the individual advertising campaigns. The individual advertising pages may be generated based on the campaign values and/or other information. The individual advertising pages may facilitate access to, and/or consumption of, the advertising content. By way of non-limiting illustration, by virtue of a first advertising campaign of a first advertiser user being specified by one or more of a first campaign value including an integration of first externally hosted content, a second campaign value including an integration of a first campaign-specific ad, and/or other values, a first advertising page may be generated. The first advertising page may include one or more of the first campaign-specific ad, a link to access the first externally hosted content, and/or other content. In some implementations, operation 204 may be performed by one or more physical processors executing a campaign component the same as or similar to campaign component 110 (shown in FIG. 1 and described herein).

At an operation 206, presentation may be effectuated of a consumer-facing user interface on individual consumer-facing computing platforms. An instance of the consumer-facing user interface may be configured to display one or more of individual campaign-specific ads for the individual advertising campaigns, individual interface elements configured to direct consumer computing platforms of consumers to the individual advertising pages, and/or other content. By way of non-limiting illustration, a consumer-facing user interface presented on one or more consumer-facing computing platforms may display the first campaign-specific ad and a first interface element configured to direct individual consumer computing platforms to the first advertising page. In some implementations, operation 206 may be performed by one or more physical processors executing a presentation component the same as or similar to presentation component 112 (shown in FIG. 1 and described herein).

At an operation 208, individual interface elements may be detected by individual consumer computing platforms. In some implementations, operation 208 may be performed by one or more physical processors of a consumer computing platform of one or more consumer computing platforms 127 (shown in FIG. 1 and described herein).

At an operation 210, responsive to the detection of the individual interface elements, the individual consumer computing platforms may be directed to the individual advertising pages to facilitate presentation of the individual advertising pages. By way of non-limiting illustration, responsive to a detection of the first interface element by a first consumer computing platform, the first consumer computing platform may be directed to the first advertising page to facilitate presentation of the first advertising page. In some implementations, operation 210 may be performed by one or more physical processors executing a consumer component the same as or similar to consumer component 114 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system to advertise, the system comprising:
one or more physical processors configured by machine-readable instructions to:
effectuate presentation of an advertiser user interface on advertiser computing platforms associated with advertiser users, the advertiser user interface being configured to obtain entry and/or selection of campaign values of campaign attributes of individual advertising campaigns of individual advertiser users, individual campaign values specifying individual characteristics of the individual advertising campaigns, individual characteristics including integration of advertising content into the individual advertising campaigns, wherein the advertising content includes externally hosted content and one or more campaign-specific ads;
generate individual advertising pages for the individual advertising campaigns based on the campaign values, the individual advertising pages facilitating access to and/or consumption of the advertising content, such that by virtue of a first advertising campaign of a first advertiser user being specified by a first campaign value including an integration of first externally hosted content and a second campaign value including an integration of a first campaign-specific ad, a first advertising page is generated, the first advertising page including the first campaign-specific ad and a link to access the first externally hosted content;
effectuate presentation of a consumer-facing user interface on consumer-facing computing platforms, the consumer-facing user interface being configured to display individual campaign-specific ads for the individual advertising campaigns and individual interface elements configured to direct consumer computing platforms of consumers to the individual advertising pages, such that the consumer-facing user interface displays the first campaign-specific ad and a first interface element configured to direct the consumer computing platforms to the first advertising page;
detect, by individual consumer computing platforms, the individual interface elements; and
responsive to the detection of the individual interface elements, direct the consumer computing platforms to the individual advertising pages to facilitate presentation of the individual advertising pages, such that responsive to a detection of the first interface element by a first consumer computing platform, direct the first consumer computing platform to the first advertising page to facilitate presentation of the first advertising page.

2. The system of claim 1, wherein the individual interface elements define addresses where assets defining the individual advertising pages are located.

3. The system of claim 2, wherein the directing of the consumer computing platforms to the individual advertising pages to facilitate presentation of the individual advertising pages is accomplished through making calls to the addresses defined by the individual interface elements, retrieving the assets at the addresses, and rendering views of the individual advertising pages based on the retrieved assets.

4. The system of claim 1, wherein the detection, by the individual consumer computing platforms, of the individual interface elements comprises image-based detection.

5. The system of claim 1, wherein the one or more physical processors are further configured by the machine-readable instructions to:
obtain profile information for the advertiser users, the profile information including advertiser profiles of the advertiser users, an individual advertiser profile of an individual advertiser user including profile values of profile attributes, individual profile values specifying individual profile characteristics of individual advertiser users, the individual profile characteristics including one or more of a business name, a business location, or a business description.

6. The system of claim 5, wherein the one or more physical processors are further configured by the machine-readable instructions to:
determine business correlation information indicating correlation between the individual advertiser users and other ones of the individual advertiser users; and
wherein the individual advertising pages of the individual advertiser users facilitate access to other ones of the individual advertising pages of the other ones of the individual advertiser users determined to be correlated.

7. The system of claim 6, wherein the correlation between the individual advertiser users and other ones of the individual advertiser users is based on one or both of business location or business description.

8. The system of claim 1, wherein the individual advertising pages include a scrollable user interface.

9. The system of claim 1, wherein the campaign attributes include one or more of a status attribute, an external content attribute, an ad attribute, a routing attribute, a custom content attribute, or a scheduling attribute.

10. The system of claim 1, wherein the externally hosted content includes one or more of social media content, restaurant-reservation services, digital distribution platform, or on-demand delivery service.

11. A method to advertise, the method comprising:
obtaining entry and/or selection of campaign values of campaign attributes of individual advertising campaigns of individual advertiser users, individual campaign values specifying individual characteristics of the individual advertising campaigns, individual characteristics including integration of advertising content into the individual advertising campaigns, wherein the advertising content includes externally hosted content and one or more campaign-specific ads;
generating individual advertising pages for the individual advertising campaigns based on the campaign values, the individual advertising pages facilitating access to and/or consumption of the advertising content, including by virtue of a first advertising campaign of a first advertiser user being specified by a first campaign value including an integration of first externally hosted content and a second campaign value including an integration of a first campaign-specific ad, generating a first advertising page, the first advertising page including the first campaign-specific ad and a link to access the first externally hosted content;
presenting of a consumer-facing user interface on consumer-facing computing platforms, the consumer-facing user interface being configured to display individual campaign-specific ads for the individual advertising campaigns and individual interface elements configured to direct consumer computing platforms of consumers to the individual advertising pages, such that the consumer-facing user interface displays the first campaign-specific ad and a first interface element configured to direct the consumer computing platforms to the first advertising page;
detecting, by individual consumer computing platforms, the individual interface elements; and
responsive to the detection of the individual interface elements, directing the consumer computing platforms to the individual advertising pages to facilitate presentation of the individual advertising pages, including responsive to a detection of the first interface element by a first consumer computing platform, directing the first consumer computing platform to the first advertising page to facilitate presentation of the first advertising page.

12. The method of claim 11, wherein the individual interface elements define addresses where assets defining the individual advertising pages are located.

13. The method of claim 12, wherein the directing of the consumer computing platforms to the individual advertising pages to facilitate presentation of the individual advertising pages is accomplished through making calls to the addresses defined by the individual interface elements, retrieving the assets at the addresses, and rendering views of the individual advertising pages based on the retrieved assets.

14. The method of claim 11, wherein the detecting, by the individual consumer computing platforms, of the individual interface elements comprises image-based detection.

15. The method of claim 11, further comprising:
obtaining profile information for the advertiser users, the profile information including advertiser profiles of the advertiser users, an individual advertiser profile of an individual advertiser user including profile values of profile attributes, individual profile values specifying individual profile characteristics of individual advertiser users, the individual profile characteristics including one or more of a business name, a business location, or a business description.

16. The method of claim 15, further comprising:
determining business correlation information indicating correlation between the individual advertiser users and other ones of the individual advertiser users; and
wherein the individual advertising pages of the individual advertiser users facilitate access to other ones of the individual advertising pages of the other ones of the individual advertiser users determined to be correlated.

17. The method of claim 16, wherein the correlation between the individual advertiser users and other ones of the individual advertiser users is based on one or both of business location or business description.

18. The method of claim 11, wherein the individual advertising pages include a scrollable user interface.

19. The method of claim 11, wherein the campaign attributes include one or more of a status attribute, an external content attribute, an ad attribute, a routing attribute, a custom content attribute, or a scheduling attribute.

20. The method of claim 11, wherein the externally hosted content includes one or more of social media content, restaurant-reservation services, digital distribution platform, or on-demand delivery service.
